(19) United States
(12) Patent Application Publication
(10) Pub. No.: US 2012/0175848 A1
(43) Pub. Date: Jul. 12, 2012

(54) TWO SHOT POLYMER BASED SLEEVE FOR JOINING PVC PIPE SECTIONS UTILIZING A RIEBER TYPE PROCESS

(75) Inventors: Stephen G. Leonard, Waterford, MI (US); Kevin Charles Baxter, Goodrich, MI (US); Robert M. Zehnder, Shelby Township, MI (US)

(73) Assignee: U.S. Farathane Corporation, Auburn Hills, MI (US)

(21) Appl. No.: 13/348,784

(22) Filed: Jan. 12, 2012

Related U.S. Application Data
(60) Provisional application No. 61/431,970, filed on Jan. 12, 2011.

(51) Int. Cl. F16L 21/02

(52) U.S. Cl. 277/624

(57) ABSTRACT

An improved Rieber type seal having an annular extending profile composed of a first thermoplastic material exhibiting a first rigidity and a second thermoplastic material having a second lesser rigidity is applied over the first material such that at least one surface of the first material is exposed upon installing within a first pipe section and contacts an inserting end of a second pipe section. The first material can include a glass filled polymer reinforced or other thermo rigid material, whereas the second material may include a softer thermoplastic backing material injected around the first material in a solidifying stage or may be one selected from the group including a thermoplastic vulcanite (TPV), thermoplastic urethane (TPU) or styrene ethylene butylene styrene (SEBS).

### CROSS REFERENCE TO RELATED APPLICATIONS

This application claims the benefit of Provisional Patent Application No. 61/431,970 filed Jan. 12, 2011.

### FIELD OF THE INVENTION

The present invention discloses an improved two shot thermoformed seal for incorporation into such as a Rieber type belling process for use in interconnecting PVC piping sections. More specifically, the present invention discloses an improved elastomeric seal joint exhibiting an improved cross sectional profile established between a first shot of such as a glass filled polymer reinforced or other thermo rigid material and a second shot of a softer backing material including such as a thermoplastic vulcanite (TPV), thermoplastic urethane (TPU) or styrene ethylene butylene styrene (SEBS). An angular rib configuration associated with the cross sectional profile of the first surface contacting glass filled polymer allows for the seal to expand and contract along with environmentally induced temperature variations. The two shot forming process further establishes a high bond line strength between the first and second thermoformed materials (often exceeding the tear strength of the plastic). An optional third shot of a slip on the install surface of the ring seal further provides additional gripping and sealing characteristics.

### BACKGROUND OF THE RELEVANT ART

The prior art is documented with examples of reinforced rubber gaskets such as interposed between interconnecting end to end connected sections of PVC pipe fittings and the like. An example of such a type of gaskets is generally known as a Rieber seal (see for example U.S. Pat. No. 4,368,894 to Parmann) and which was developed in order to address certain problems, including such as the dislodging of a homogeneous and non-reinforced elastomeric gasket from an associated inner annular bell groove during insertion into the bell of an engaging spigot end of a succeeding PVC pipe section, this compromising the sealing characteristics of the joint.

Conventional Rieber seals include such a steel wire or flattened band which is either externally or internally bonded, such as proximate the exterior perimeter of the annular extending elastomer body and is locked into place within the bell groove due to pre-stressing of the elastomer against the inner annular wall of the pipe, with the additional advantage of such anchoring of the gasket preventing the penetration of soil and other foreign particles into the sealing zone established between the outer walls of the gasket and the internal walls of the bell where the gasket is seated. In this fashion, the steel ring operates to hold open the seal for subsequent inter-assembly and during the initial belling process.

More recent examples of two part gaskets for pipe-to-pipe connections include such as disclosed in Happel, U.S. Pat. No. 7,252,293 and which teaches a two part body having a substantially rectangular profile and including a relatively rigid component joined to a relatively resilient component. The resilient component includes a radially inwardly projecting sealing lobe for providing a compressive seal with the spigot end of a pipe, a reinforcement portion of the rigid component being disposed between the sealing lobe and the pipe bell end to provide a radially non-compressive reaction surface against which the sealing lobe is compressed. The rigid component further includes a tapered leading edge portion for aligning and centering the spigot end of a pipe upon insertion within the gasket, the leading edge portion being reinforced by a plurality of circumferentially spaced ribs.

### SUMMARY OF THE PRESENT INVENTION

The present invention discloses an improved Rieber type seal in which a first thermoplastic material having a first rigidity exhibits an annular extending profile with a cross sectional profile and a second thermoplastic material having a second lesser rigidity is applied over the first material such that at least one surface of the first material is exposed and, upon installing within a first pipe section, contacts an inserting end of a second pipe section. The first material can include a glass filled polymer reinforced or other thermo rigid material exhibiting a “V” profile.

The second material may further include a softer thermoplastic backing material injected around the first material in a solidifying stage or may be one selected from the group including a thermoplastic vulcanite (TPV), thermoplastic urethane (TPU) or styrene ethylene butylene styrene (SEBS). The second material may further terminate in an outer lip edge as well as an opposite/inner biasing lobe edge. The invention further contemplates a third shot slipcoat applied over the exposed surface of the first material.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an assembled lengthwise cutaway of the improved Rieber type seal according to one non-limiting example of the present invention installed between end-to-end engaging locations of first and second lengths of pipe;

FIG. 2 is a first cutaway perspective illustrating a first example of an interface profile established between first and second polymer based materials produced according to a generally Rieber belling seal process and such as according to that previously depicted in FIG. 1;

FIG. 3 is an end view of the ring profile established by the first and second materials illustrated in FIG. 2;

FIG. 4 is a cutaway perspective similar to FIG. 2 and of a second example of a ring profile;

FIG. 5 is a cutaway perspective of a third example of a ring profile; and

FIGS. 6A-6C illustrate, in succession, examples of prior art, V4D and V5D sections taken from selected ring profiles and further including the optional addition of a third shot slipcoat surface.

### DETAILED DESCRIPTION OF THE PREFERRED EMBODIMENTS

As previously described, the present invention discloses an improved two shot thermoformed seal for incorporation into such as a Rieber type belling process for use in interconnecting PVC piping sections and which addresses deficiencies associated with installation of prior Rieber type seal designs, in particular during the belling process associated with such initial gasket or seal assembly within a widened receiving (female) end of a pipe section and prior to end to end engaged assembly of pipe sections in the field. As is known, the Rieber ring is a locked in/fixed elastomeric ring seal utilized in pressurized PVC piping.

Specifically, the conventional Rieber ring design is steel reinforced and is incorporated into the pipe-end socket during the manufacturing process, thus rendering the seal an integral (or locked in) part of the pipe which is ideally suited for water pressure and sewer/drainage pipes. As is further known, the outwardly facing steel ring component holds the seal open for the belling process and to ensure the seal is open for assembly in the field. Problems associated with such conventional seal designs further include mechanical fracture, including delamination from the backing thermo layer, as well as corrosion of the steel ring.

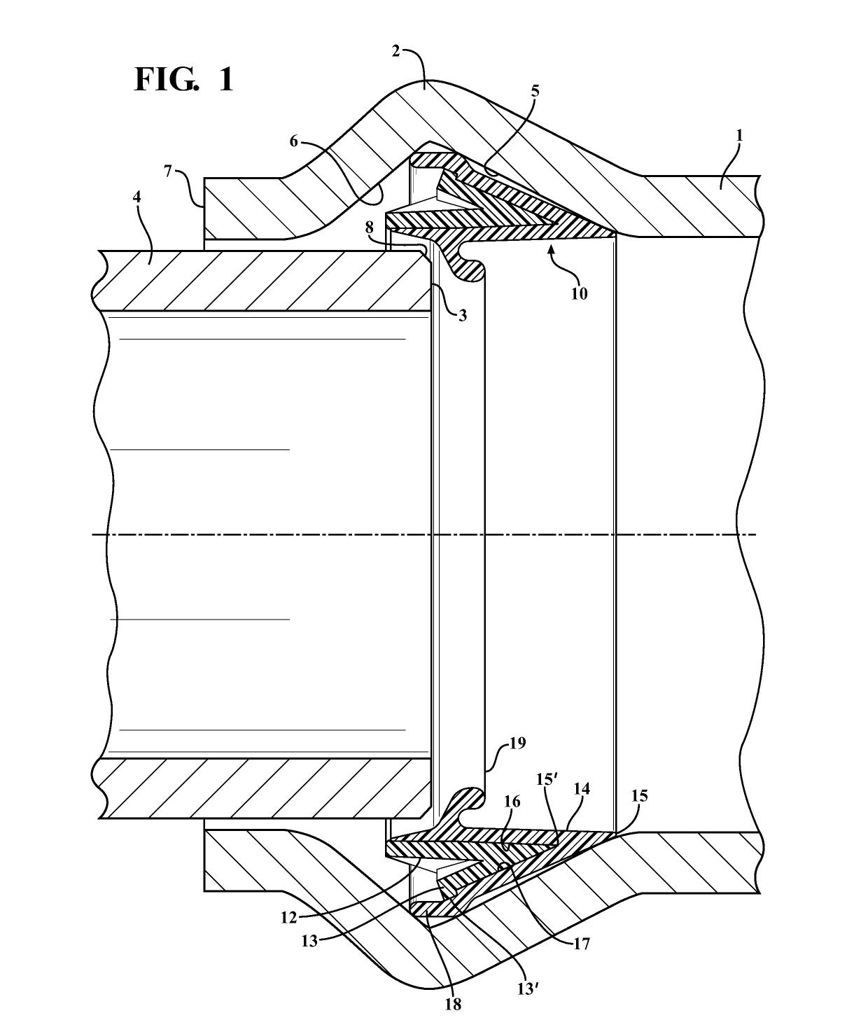

Referring initially to FIG. 1, reduced length and interconnecting end sections are shown in lengthwise cutaway of a first length of pipe 1 exhibiting an annularly enlarged female receiving (or spigot) end 2 which contains a pre-installed seal 10 and into which is installed an inserting, or male end 3 of a further pipe section 4. As previously described, the end to end connected pipes 1 and 4 can include, without limitation, a PVC (polyvinyl chloride) material however are further understood to not be limited in either construction or configuration.

Also depicted in the lengthwise cutaway of FIG. 1 is the lead-in angle associated with the spigot end 2 of the receiving pipe 1 and which includes a first outwardly angled surface 5 and a succeeding and communicating inward reverse angle 6 (this defining the annular extending bell profile associated with the spigot and which is understood in the art to correspond to the belling or pre-installation process for mounting the gasket 10 within the open end of the pipe 1 prior to subsequent end to end pipe installation in the field). The first pipe 1 as further shown terminates, at open end profile 7, in a leveled end profile defining the inserting cavity for receiving the end 3 of pipe 4. The inserting end 3 of pipe 4 further exhibits a tapered outer diameter notch, see at 8, this facilitating assembly within the spigot 2 of receiving pipe 1 with the seal 10 pre-installed in place.

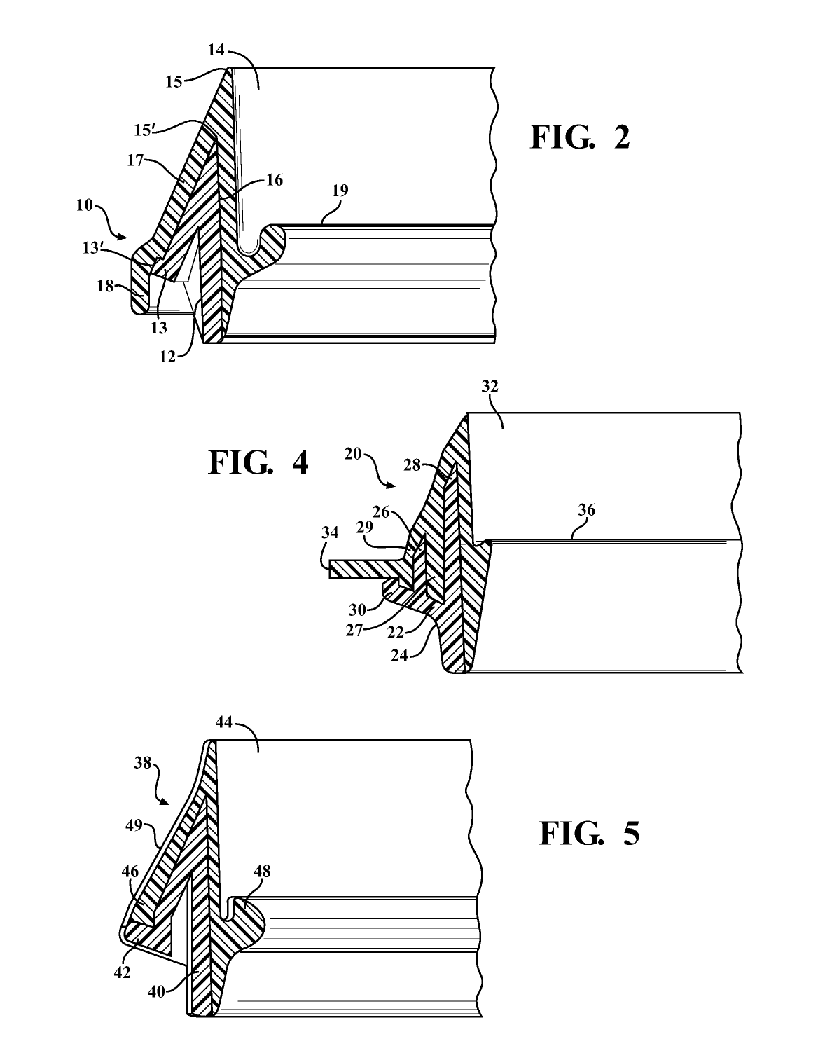

Referring now to FIG. 2, in combination with the environmental installation of FIG. 1, the cutaway perspective generally at 10 is again depicted illustrating a first example of an interface profile established between first and second polymer based materials produced according to a generally Rieber belling seal process and according to the present invention. The Rieber type seal defined by the present invention improves upon existing seal designs constructed of first and second injection molded thermo-based materials, such as in particular regards to the angular rib configuration established between the harder “first shot” material and the softer “second shot” material as typically occurring during an associated injection molding operation in which the seal is produced.

As depicted in each of FIGS. 1 and 2, a first shot (defined to include injection molding or any other suitable forming process) material 12 is provided of a higher resilient thermo polymer material which substitutes for the outer annular steel ring positioned along a lead-in surface associated with prior art belled Rieber pipe ring seal designs. The first shot 12 includes such as a glass filled polymer reinforced or other thermo rigid material and, in the illustrated variant, exhibits a sharp “V” profile with an outer turned edge 13 (as well as an outwardly stepped or projecting profile 13′) and which, upon installing the ring within the accessible spigot end 2 of the first PVC pipe section 1, defines an annularly accessible pocket or seat for receiving an inserting edge profile of the succeeding PVC or like pipe section 4.

During initial seal manufacture, a second shot of a softer thermoplastic backing material 14 is injected around the solidifying first shot 12 (such as to enhance the line bonding strength established between the materials) and includes such as a thermoplastic vulcanite (TPV), thermoplastic urethane (TPU) or styrene ethylene butylene styrene (SEBS). The softer backing material 14 as depicted in cutaway exhibits a similar sharpened V-profile, see including inner pointed base edge 15 which corresponds to a similar edge 15′ defining the inner harder material 12, and further so that edge extending boundaries 16 and 17 are established between the outer facing angled sides of the inner harder material 12 and mating inner facing angled sides of the outer softer backing material 14.

As further depicted in each of FIGS. 1 and 2, the outer material 14 terminates in an outer lip edge 18 which is additionally retained in place along its underside extending surface by the projecting profile 13′ associated with the harder material 12. As shown in FIG. 1, the outer lip edge 18 seats against the inner angled edge of the spigot 2 defining its greatest diameter dimension and which is again located at the lead in angle defining surfaces 5 and 6 associated with the spigot 2 of the first PVC pipe section 1. An opposite/inner biasing lobe edge 19 extending from the backing material 14 defines a generally abutment end stop with the inserting profile edge 3 of the second pipe section 4 and shown in FIG. 1.

Although not shown, a separate brush or spray on lubricant material can be used during field installation of the pipe sections and such as to facilitate mating engagement of the inserting edge 3 of the succeeding pipe section 4 in proper annular seating and engaging fashion with the inner profile edges of the seal 10 which has again been previously mounted within the belled location of the initial pipe section 1 associated with its receiving spigot 2. Without limitation, the lubricant can be applied to either or both the inserting portion 3 of the pipe 4, as well as to the inner spigot 2 and/or seal 10 defining surfaces against which the outer profile of the pipe 4 seats or abuts.

The angled cross sectional configuration of the first material 12 as described and further such as is additionally shown in succeeding variants is selected so as to increase both bonding surface area with the backing material 14 as well as to enhance the strength and performance characteristics of both materials 12 and 14. As further illustrated in the end view of FIG. 3, an angular rib configuration, see at 19′, is associated with the cross sectional profile of the first surface contacting glass filled polymer (first material 12) and allows for the seal 10 to expand and contract along with environmentally induced temperature variations. As previously noted, the two shot forming process establishes high bond line strength between the first and second thermoformed materials (often exceeding the tear strength of the plastic).

Referring now to FIG. 4, a cutaway is generally shown at 20 shown in perspective, similar to FIG. 1, and of a second example of a seal exhibiting a ring profile in which a first shot thermo material 22 exhibits an alternatively curved outer profile (see further at 24), combined with a pair of lengthwise extending and spaced apart support ribs 26 and 28 and a further extending edge 30 (similar to that depicted at 13 in FIG. 1 and again including a projecting edge location). The second shot material is further shown at 32, similar in composition to that described in FIG. 1, and which is again formed around and over the first shot thermo material 22, with corresponding and opposingly seating ribs 27 and 29, such that both materials 22 and 32 set simultaneously in order to facilitate increased bond line strength associated with a correspondingly increased bond line area resulting from the plural and overlapping profile associated with the multiple ribs 26 & 28 and 27 & 29.

The cross sectional profile of the second shot 32, generally similar to that identified at 14 in FIG. 1, includes both an edge extending portion 34 which can engage the inner lead in angled edge of the spigot 2 in similar fashion as the lip edge 18, as well as an inner ribbed support 36 (this corresponding to the lobe edge 19 in FIG. 1) which is application-ally similar to that depicted at 19 in the seal 10 installed in FIG. 1 to provide an abutment stop to the inserting end profile of the succeeding pipe section 4. Otherwise, the seal 20 installs and functions in a similar fashion as that previously described and depicted at 10 in FIGS. 1 and 2 in relation to the pipe architecture described.

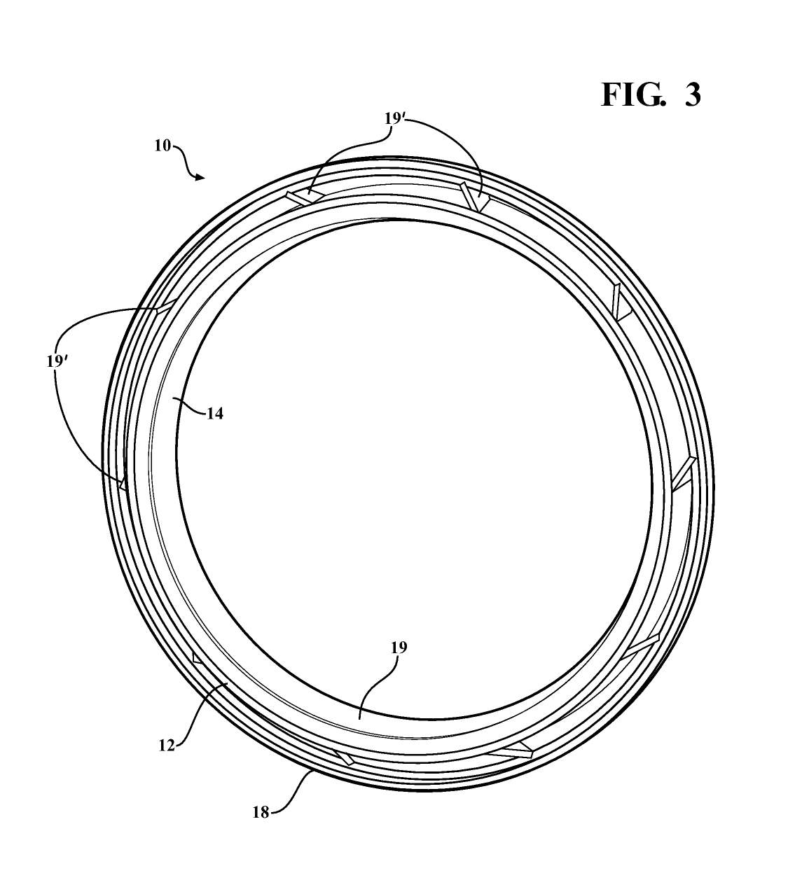

FIG. 5 presents a further cutaway perspective, generally at 38, of a third example of a seal exhibiting a ring profile which is similar to that depicted in FIG. 1 and includes a first shot 40 again including such as a glass filled polymer reinforced or other thermo rigid material and, in the illustrated variant, exhibits another example of a sharp “V” profile with an outer turned edge 42 and which, upon installing the ring within an accessible end of a first PVC pipe section, defines an annularly accessible pocket or seat for receiving an inserting edge profile of a succeeding PVC pipe section. A second shot of a softer thermoplastic backing material 44 is injected around the solidifying first shot 40 and surrounds the annular extending first shot 40 and further, as depicted in FIG. 1, terminates in an outer, generally flush, edge 46 (this again seating against the annular inner surface of the first PVC pipe section), as well as an opposite/inner biasing lobe edge 48, such as again in use defining an abutment stop for seating an inserting end of a male pipe section 4 such as depicted in FIG. 1.

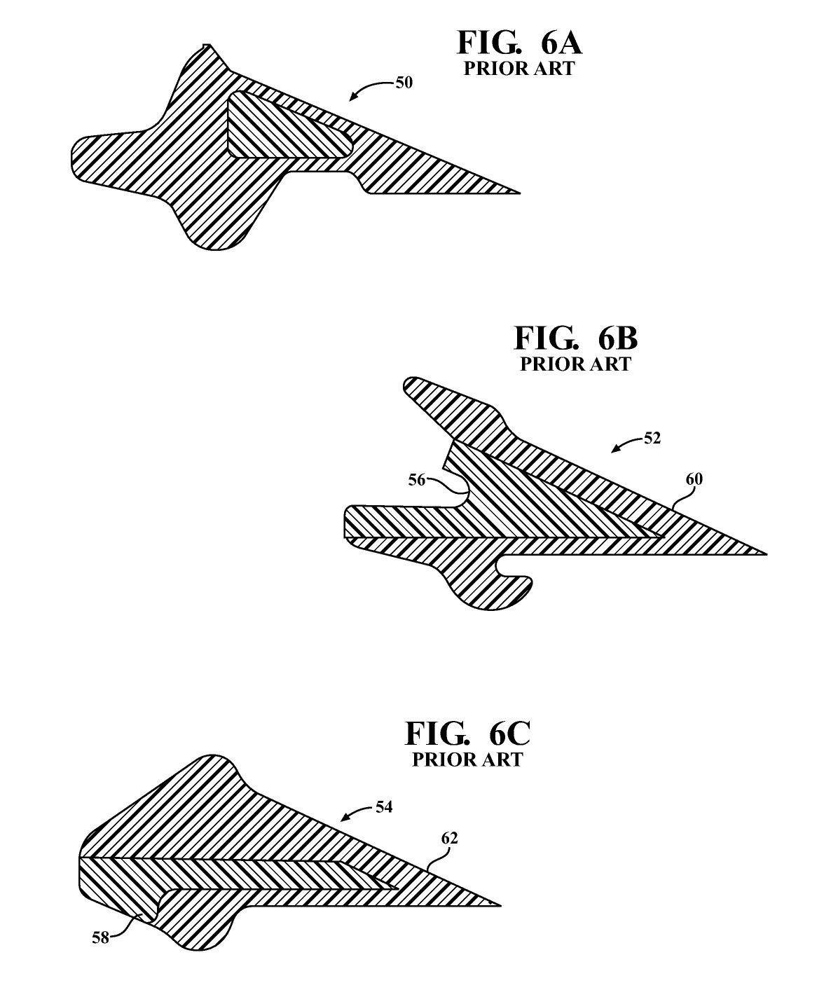

Referring finally to FIGS. 6A-6C illustrated in succession are examples of each of prior art (at 50 in FIG. 6A), V4D (at 52 in FIG. 6B) and V5D (at 54 in FIG. 6C) sections taken from selected ring profiles. The 4D (FIG. 6B) and 5D (FIG. 6C) sections, given the location of the first shot of material in similar respects to those previously depicted in the variants of FIGS. 1-4, have been found to be more prone to delaminating during the final install and due to the first shot of rigid material (depicted in section at 56 in FIG. 6B and further at 58 in FIG. 6C) not fully encapsulated (unlike that generally shown again at 50 in FIG. 6A) within the softer second shot material (further at 60 in FIG. 6B and 62 in FIG. 6C). Consequently, a further desired component contemplates the optional addition of a third shot slipcoat surface material (such as exhibiting any type of thermoplastic resin exhibiting selected deforming and/or frictionally resistive properties) applied onto the install surface of the ring seal, and which by non-limiting example is depicted by third shot slipcoat surface 49 in FIG. 5, this in order to provide additional gripping and sealing characteristics.

Accordingly, the present invention discloses a lighter weight thermo based ring seal as compared to existing Rieber type seals while also overcoming many of the afore mentioned problems ascribed to the steel ring component associated with such prior art seals, these again including corrosion and mechanical fracture/delamination. The use of a two shot polymer based application for creating the ring seal further eliminates production steps leading to lower manufacturing cost.

Having described our invention, other and additional preferred embodiments will become apparent to those skilled in the art to which it pertains and without deviating from the scope of the appended claims.

We claim:

1. An improved Rieber type seal, comprising:
a first thermoplastic material having a first rigidity and exhibiting an annular extending profile with a cross sectional profile; and
a second thermoplastic material having a second lesser rigidity applied over said first material such that at least one surface of said first material is exposed and, upon installing within a first pipe section, contacts an inserting end of a second pipe section.

2. The invention as described in claim 1, said first material further comprising a glass filled polymer reinforced or other thermo rigid material exhibiting a “V” profile.

3. The invention as described in claim 1, said second material further comprising a softer thermoplastic backing material injected around said first material in a solidifying stage.

4. The invention as described in claim 3, said second material further comprising at least one selected from the group including a thermoplastic vulcanite (TPV), thermoplastic urethane (TPU) or styrene ethylene butylene styrene (SEBS).

5. The invention as described in claim 3, said second material terminating in an outer lip edge as well as an opposite/inner biasing lobe edge.

6. The invention as described in claim 3, further comprising a third shot slipcoat applied over said exposed surface of said first material.

7. An annular seal for installation within a receiving spigot end of a first pipe section and within which an inserting end of a second pipe section is subsequently installed, the first pipe section exhibiting a lead in angle including a first outwardly angled surface and a succeeding inwardly angled surface proximate an open end profile, said seal comprising:
a body including a first thermoplastic material having a first rigidity and exhibiting an annular extending and cross sectional profile exhibiting a least first and second angularly offset portions extending from a common edge; and
a second thermoplastic material having a second lesser rigidity than said first material and which is applied over said first material such that at least one surface of said first material is exposed and, upon installing within the first pipe section, contacting an inserting end of the second pipe section.

8. The invention as described in claim 7, said first material further comprising a glass filled polymer reinforced or other thermo rigid material exhibiting a “V” profile.

9. The invention as described in claim 7, said second material further comprising a softer thermoplastic backing material injected around said first material in a solidifying stage.

10. The invention as described in claim 9, said second material further comprising at least one selected from the group including a thermoplastic vulcanite (TPV), thermoplastic urethane (TPU) or styrene ethylene butylene styrene (SEBS).

11. The invention as described in claim 9, said second material terminating in an outer lip edge as well as an opposite/inner biasing lobe edge.

12. The invention as described in claim 9, further comprising a third shot slipcoat applied over said exposed surface of said first material.

13. The invention as described in claim 7, said first and second materials further comprising a V shape in cross section.

14. The invention as described in claim 7, said second material further comprising an inner radially projecting lobe which contacts the inserting end of the second pipe section.

15. The invention as described in claim 7, each of said first and second materials exhibiting a plurality of overlapping and spaced apart ribs resulting in an increased bonding area.

16. The invention as described in claim 11, said outer lip edge adapted to seating against an inner facing surface of the lead in angle of the first pipe section spigot defining its greatest diameter dimension.

17. An annular seal for installation within a receiving spigot end of a first pipe section and within which an inserting end of a second pipe section is subsequently installed, the first pipe section exhibiting a lead in angle including a first outwardly angled surface and a succeeding inwardly angled surface proximate an open end profile, said seal comprising:
a body including a first thermoplastic material having a first rigidity and exhibiting an annular extending and cross sectional profile exhibiting a least first and second angularly offset portions extending from a common edge; and
a second thermoplastic material having a second lesser rigidity than said first material and which is applied over said first material such that at least one surface of said first material is exposed;
said second material terminating in an outer lip edge as well as an opposite/inner biasing lobe edge, said outer lip edge adapted to seating against an inner facing surface of the lead in angle of the first pipe section spigot defining its greatest diameter dimension, said lobe edge contacting an inserting end of the second pipe section upon installing within the first pipe section.

18. The invention as described in claim 17, said first material further comprising a glass filled polymer reinforced or other thermo rigid material exhibiting a “V” profile.

19. The invention as described in claim 17, said second material further comprising a softer thermoplastic backing material injected around said first material in a solidifying stage.

20. The invention as described in claim 19, said second material further comprising at least one selected from the group including a thermoplastic vulcanite (TPV), thermoplastic urethane (TPU) or styrene ethylene butylene styrene (SEBS).
